(19) United States
(12) Patent Application Publication
(10) Pub. No.: US 2024/0333083 A1
(43) Pub. Date: Oct. 3, 2024

(54) ELECTRONICS CONSTRUCTION KIT

(71) Applicant: RAPA Automotive GmbH & Co. KG, Selb (DE)

(72) Inventors: Tim RUBITZKO, Selb (DE); Rocco KEMNITZ, Selb (DE)

(73) Assignee: RAPA Automotive GmbH & Co. KG, Selb (DE)

(21) Appl. No.: 18/594,704

(22) Filed: Mar. 4, 2024

(30) Foreign Application Priority Data
Mar. 29, 2023 (DE) 102023108059.8

(51) Int. Cl. H02K 5/22; B60G 17/015; B60G 17/08; F04B 17/03

(52) U.S. Cl. CPC H02K 5/225; B60G 17/0157; B60G 17/08; F04B 17/03; B60G 2204/20

(57) ABSTRACT

A motor-pump unit for making available hydraulic energy, in particular in a chassis system of a vehicle. An electronic unit has a power board with power electronics and a, preferably constructively separated, signal board.

### FIELD

The present invention relates to a motor-pump unit, a motor-pump-unit axle set and a construction set therefor, as well as a chassis axle and a chassis system.

### BACKGROUND

Active chassis systems are known, for example, from DE 39 02 743 C1 or DE 2 020 292 A1. A distinction is made here, for example, between completely active and semi-active chassis systems, in which the suspension can be regulated actively either for each wheel individually or per axle. An active chassis has hydraulically controllable or regulated shock absorbers, in which the two cylinder chambers or damper chambers of the working cylinder of a shock absorber are not merely interconnected via one or several, optionally controllable damping valves or throttle valves (damper adjustment valves), but in which, for example, the filling state of the cylinder chambers is controlled actively, and correspondingly hydraulic forces can be guided as needed into the chassis. The two cylinder chambers of a shock absorber can be connected, for example, parallel or alternatively to the damping valves or throttle valves, via a hydraulic pump that can be driven by an electric motor, and can optionally also drive said electric motor as an electric generator or electric motor generator (recuperation operation). Additionally or alternatively, also other settings optionally can be effected in the shock absorber with the aid of the pump.

By pumping hydraulic fluid it is possible, for example, to counteract pitching or rolling motions of the vehicle. Conversely, such an arrangement of shock absorber, hydraulic pump and electric motor can also feed electric energy obtained by recuperation back into the on-board network of the vehicle. Different shock absorbing behaviors can also be set here, for example “soft” or “hard”, or also depending on the driving behavior and/or the road surface conditions.

The hydraulic pump and the electric motor generator or electric motor are thus generally employed in the active chassis for guiding hydraulic energy into or out of the (chassis) system. The pump and the electric motor usually form a common, compact construction unit here, which will be referred to as motor-pump group in the following. When there is further fixedly arranged a drive unit or regulation unit (electronic unit, ECU) on the motor-pump group, this is also referred to as a motor-pump unit (MPU). Such motor-pump groups or motor-pump units thus convert electric energy into hydraulic energy, and optionally also vice versa.

Until a few years ago, only a 12 V on-board network was found throughout in motor vehicles. Meanwhile, driven by hybrid and electric vehicles, in many motor vehicles there exist two or more (partial) on-board networks with different electric voltage levels. Usually, a 12 V on-board network is still present, and besides, there exists at least one further on-board network or power on-board network with a higher voltage level, for example 24 V, 48 V, 400 V or 800 V, via which high-power loads are then supplied.

### SUMMARY

It is the object of the invention to state a motor-pump unit that can be adapted to various installation situations with little effort. It is a further object of the invention to state a corresponding construction set for this, as well as a chassis axle and a chassis system with such a motor-pump unit.

The motor-pump unit according to the invention (in the following also referred to as MPU) is an apparatus for supplying or for guiding in and/or out hydraulic energy, in particular into or out of a chassis system of a vehicle. The MPU according to the invention comprises:
a motor-pump group with a hydraulic pump and an electric motor or electric motor generator for driving the hydraulic pump, and
an electronic unit for regulating or operating the motor-pump group, that is for the emitting or exchanging control signals and/or for the electric power supply of or for electrically driving the electric motor.

According to the invention, the electronic unit has two circuit boards, a power board with power electronics for the electric motor and a signal board.

The power board has the, preferably all of the, components required for the electric power supply to the electric motor and/or all power-electronic components of the electronic unit, so that, in the simplest case, power-electronic components in the electronic unit or in the MPU are arranged exclusively on the power board. The electronic unit or the power board supplies directly and immediately the, preferably all of the, coil currents and/or motor-phase currents for the electric motor of the motor-pump group. In the simplest case, exclusively the electronic unit and/or in the electronic unit exclusively the power board is immediately electrically connected to the electric motor or to the magnetic coils of the electric motor, preferably via exactly or at least three (single-core) motor-phase lines or magnetic-coil supply lines.

In contrast, the signal board preferably does not have any power-electronic components.

Further, the power board of the electronic unit is laid out for a predetermined voltage level (of a (n) (power) on-board network of a vehicle). Correspondingly, due to the arrangement of the power electronics exclusively on the power board, in the electronic unit merely the power board, but not the signal board, has to be adapted and/or exchanged for adaptation of the MPU to a different installation situation with different voltage level (for example in a different (power) on-board network). This decreases the adaptation effort for the MPU and increases the number of same parts in the electronic unit and/or the MPU (modular design principle or construction kit principle), thus decreasing the component costs.

In the simplest case, the power board and the signal board are two different, mutually (constructively) separate and/or spaced-apart circuit boards. However, in principle, the power board and the signal board can also be two different, mutually delimited regions on a single or common circuit board, wherein the signal board and the power board preferably form respectively exactly one continuous region on the common circuit board and/or divide the common circuit board into two respectively continuous regions, for example into halves.

The power board and the signal board preferably have different voltage levels (during operation), i.e. the power board and the signal board are set up for different voltage levels. The power board in particular has a high-voltage voltage level and the signal board has a low-voltage voltage level, which is lower than the high-voltage voltage level.

The voltage level is usually understood to mean the or the highest (direct) current with which a given circuit board (or generally a component) is supplied during operation (supply voltage). However, the voltage level is optionally the highest voltage occurring on the circuit board during operation and/or the (maximal) voltage for which the circuit board (or the component) is set up. The circuit board is therefore set up for a voltage of at least or exactly the voltage level with respect to its construction type, voltage resistance and/or ampacity. The voltage level is the nominal voltage in the simplest case, i.e. the voltage that is provided during operation as intended.

The high-voltage voltage level preferably amounts to 12 V, 24 V, 48 V, 400 V or 800 V and/or the low-voltage voltage level amounts to 5 V, 12 V, 24 V or 48 V.

The power electronics of the power board preferably comprise components such as power (switching) transistors and/or a B6 bridge and preferably a gate driver therefor and/or an intermediate circuit capacitor and/or an EMV filter, comprising, for example, a common-mode choke and/or Y capacitors, and/or high-voltage current measuring shunts and/or a voltage converter or transformer from the high voltage to the low voltage or high-voltage voltage level to low-voltage voltage level and/or a (low-voltage) supply-voltage interface for the voltage supply of the signal board by the power board, i.e. for generating or making available the low voltage for the signal board, wherein the supply-voltage interface is preferably integrated in the power-board plug (described in the following) or forms part thereof. Further, the power board has a (high-voltage) supply voltage interface for supplying the power board or is connected immediately to a (high-voltage) supply voltage interface and/or set up as a recipient of a (high-voltage) supply voltage. A B6 bridge (or its switches), for example, immediately regulates the (three) phases or the coil windings of the electric motors. The components and/or power transistors of the power electronics consist of or comprise integrated (electronic and/or semiconductor) components, in particular
power MOSFETs (power metal oxide semiconductor field-effect transistor; in particular for a voltage level of 48 V) and/or
bipolar transistors with insulated gate electrode (insulated-gate bipolar transistor, IGBT, or Si-IGBT; in particular for a voltage level of 400 V or 800 V) and/or
SiC-MOSFETs (silicon carbide, SiC; in particular for a voltage level of 400 V or 800 V).

The signal board, in contrast, comprises as a component preferably at least one microprocessor and/or an FPGA (field programmable gate array) and/or a central signal processing unit (central processing unit, CPU), which is preferably set up for the (logic or signal) control of at least or exactly the complete MPU. Further, the signal board preferably has a bus interface or is immediately connected to a bus interface of the electronic unit or of the MPU and/or is set up as a participant for a bus, wherein the bus is preferably a CAN bus, a CAN-FD bus or a Flexray bus. Moreover, the signal board can have a supply-voltage interface for the voltage supply of the signal board by the power board, i.e. for receiving a (low-voltage) supply voltage from the power board (preferably in addition to a low-voltage voltage supply via the bus interface), wherein the supply-voltage interface is preferably integrated in the signal-board plug (described in the following) or forms part thereof and/or is separate from the bus interface, for example forming a component separate from the bus interface.

It is advantageous here if the supply-voltage interface and the bus interface on the signal board are (completely) galvanically separated from each other (galvanic separation). Even if, in the event of an error, high voltage is guided unintentionally to the signal board by the low-voltage voltage supply of the power board, a passing through of this high voltage unintentionally being present at the supply-voltage interface of the signal board to the bus interface of the signal board and thus to the bus system is prevented thereby. In the simplest case, the signal board has exactly or at least two (completely) galvanically mutually separated regions, of which a first partial region comprises exactly or at least the bus interface and a second partial region of which comprises exactly or at least the supply voltage interface. As galvanic separating elements, preferably capacitive and/or (electric-) optical couplers are employed. The central signal processing unit (or the microprocessor or the FPGA) is arranged preferably in the second partial region and thus galvanically separated from the bus interface. Alternatively, the central signal processing unit (or the microprocessor or the FPGA) can be arranged also in the first partial region and is thus galvanically separated from the supply-voltage interface.

In a preferred embodiment the two circuit boards of the electronic unit are mechanically fixedly and/or electrically interconnected via a plug-in system. Preferably, the power board and the signal board are electrically interconnected exclusively via the plug-in system. The electronic unit here comprises two corresponding (multipolar) (circuit-board) plugs, of which a first plug (power board plug) is (rigidly or fixedly) attached and/or soldered to the power board and a second plug (signal-board plug) is (rigidly or fixedly) attached and/or soldered to the signal board. In the electronic unit (ready for operation) the power board and the signal board are then connected via the two corresponding plugs to a stack and are correspondingly spaced apart by the plug-in system and/or the two mutually engaging circuit-board plugs. Such a plug-in system simplifies making available the electronic unit and/or exchanging or installing the power board.

The two circuit boards (power board and signal board) are arranged preferably parallel to each other and/or they mutually overlap (partially) and/or have identical dimensions and/or are configured and/or arranged to be completely congruent to each other. Preferably, (all) power switching transistors of the power board are arranged on the side of the power board facing away from the signal board, which promotes their heat dissipation.

In a further preferred embodiment the electronic unit and/or the signal board are set up for regulating or operating, i.e. for emitting and/or exchanging electric control signals and/or for the electric power supply of or for electrically driving exactly or at least one external apparatus (external with respect to the MPU), in particular for regulating one or several damper adjustment valves. This permits shifting the control logic and/or the control procedures for the at least one external apparatus to the electronic unit (present anyway) or to the signal board of the electronic unit of the MPU and/or generating the regulation signals for the external apparatus in the electronic unit or in the signal board. An otherwise required, special or dedicated control device for the external apparatus can thus be omitted and thus the total number of control devices in the system, in particular in the chassis system, can be reduced. In addition, the external apparatus can be controlled at the same time, for example by a superordinate control device, via the bus interface of the MPU, which also reduces the wiring effort.

The electronic unit and/or the signal board is preferably configured as a force modulator for exactly or at least one shock absorber. A shock absorber comprises exactly or at least one electrically regulatable or adjustable damper adjustment valve (which constitutes an external apparatus described above). The electronic unit and/or the signal board of the MPU combines as a force modulator the hydraulic regulation of the shock absorber via the pump and the electric regulation of the damper adjustment valve. The electronic unit and/or the signal board is thus set up to modulate the interaction of the pump and/or of the motor-pump group and the damper adjustment valve. A superordinate control device or chassis control device in the simplest case only has to specify a desired damper force (via the bus interface) of the electronic unit or the signal board and/or an external force modulator in the form of a dedicated, interposed control device can be omitted. Correspondingly, the MPU is set up to be regulated by a (superordinate) chassis control device directly and immediately (via the bus interface) and, in particular, to receive and/or to process the desired damper force for the shock absorber as the only target value.

In a further preferred embodiment of the MPU the power board is set up to generate a or exactly the one supply voltage of the signal board and particularly preferably to supply the signal board therewith via the plug-in system. Thus, only (exactly) one voltage supply connector for the supply voltage of the high-voltage voltage level has to be provided in the MPU, while a dedicated voltage supply connector for the signal board (e.g. by a further (partial) on-board network, e.g. a 12 V on-board network) can be omitted.

The electric motor or electric motor generator of the motor-pump group is preferably a brushless, permanently excited motor, in particular a synchronous motor, in particular a three-phase synchronous motor, with preferably exactly three motor-phase supply lines, via which a stator with magnetic coils generates a rotating field for a rotor equipped with permanent magnets thereon. The electric motor is preferably a rotational-speed variable drive which can be operated as an actuator motor and is set up and provided for moving towards and/or holding in targeted manner predetermined settings or positions. The electric motor and the regulator (electronic unit) further preferably create a bidirectional drive, which can be operated in both rotational directions, and particularly preferably is also four-quadrant enabled, meaning that it can be operated also as an electric generator (electric motor generator) in both rotational directions and can thus also guide or remove hydraulic energy out of the system, for example from the chassis, and convert it into electric energy.

The hydraulic pump of the motor-pump group is preferably a gear pump, particularly preferably an internal gear pump. It is preferably leakage-compensated, i.e. it has only small and/or negligible leakages, so that the conveyed amount of hydraulic fluid is fixedly coupled to the rotation or the number of rotations (high volumetric degree of efficiency). Correspondingly, the motor-pump group can preferably be operated as an actuator pump or actuator drive for a load, in particular a shock absorber, and is suitable, for example, for moving towards and holding in targeted manner predetermined hydraulic settings or positions of the load. The hydraulic system usually has no pressureless tank and/or the electric motor is preferably not operated in continuous operation and/or continuously at a constant rotational speed. A motor-pump group with a leakage-compensated internal gear pump for reversing operation is known, for example, from DE 10 2014 103 958 A1, the disclosure content of which is included in the disclosure content of the present description, in particular with respect to the configuration of the internal gear machine (axial sealing disks, radial sealing elements, etc.).

In a preferred embodiment the MPU or the motor-pump group and the electronic unit are arranged in a common casing, a so-called MPU casing (motor-pump unit casing), which is usually a multi-part casing. This multi-part MPU casing is joined exactly or at least from
a motor-pump casing (in which the motor-pump group is preferably received completely) and
an electronic casing or electronic lid different therefrom (in which the electronic unit is preferably received completely).

The electric lines between the electronic unit and the motor-pump group or its electric motor preferably extend completely within the MPU casing. Further, the MPU casing forms a closed, sealed casing, which is sealed against soiling and other environmental influences, for example airtight, waterproof or splash-waterproof, with the MPU thus being installable on a lower side of a vehicle. The MPU casing is further preferably also sealed or shielding against electromagnetic radiation, which is generated, for example, due to high alternating currents in the electric motor, in order to minimize or reduce the electro-magnetic exposure (or EMC exposure) and/or to increase the EMC (electro-magnetic compatibility). The common MPU casing preferably comprises on its outer side, in particular on the outer side of the electronic casing, as the electric interfaces at least or exactly one bus interface (e.g. for a CAN bus, a CAN-FD bus or a Flexray bus) and exactly one supply voltage interface, in particular for a high voltage of, for example, 400 V or 800 V and/or for the high-voltage voltage level. Further, the electric motor preferably has no electric switching components and/or no integrated (electronic) components within the motor casing.

In the motor-pump group the hydraulic pump and the electric motor or the electric motor generator are usually fixedly interconnected via a rotating motor shaft, wherein the motor shaft axle usually forms also a longitudinal axis for the motor-pump group and the complete MPU. The motor-pump casing is usually a multi-part casing and is composed of, for example
a (preferably single-piece) motor casing forming that section or part of the motor-pump casing that accommodates the electric motor or electric motor generator and preferably encloses it completely, and
a pump casing forming that section or part of the motor-pump casing that accommodates the pump and preferably encloses it completely.

The pump casing forms or comprises, for example, also a pump lid, which preferably (completely) encloses the pump on an axial front side of the motor-pump casing and/or (also) forms the axial front side of the motor-pump casing. Through the axial front side there extends the axis or the extension of the motor shaft of the motor-pump group. The axial front side preferably extends normally or substantially normally to the motor shaft axis and/or is preferably configured to be substantially or completely planar.

In a preferred embodiment the MPU casing and/or the electronic casing comprises, besides the bus interface and the supply voltage interface, a further electric interface or an additional interface for regulating the exactly or at least one external apparatus, in particular exactly or at least one damper adjustment valve. This additional interface forms a (further) electric casing lead-through, wherein on the outer side of the casing there is preferably arranged an electric plug.

In a further preferred embodiment of the MPU the power board is arranged spatially more closely to the motor-pump casing and/or the motor casing than the signal board and/or extends parallel to the motor shaft. The power board is thus located in spatial proximity to the motor-pump casing or the motor casing, which then contributes to heat dissipation. In addition, on the power board preferably the or all components of the power electronics are arranged on the side of the power board facing towards the motor-pump casing or motor casing, which additionally promotes heat dissipation. Particularly preferably the or all components of the power electronics are in thermal and/or mechanical contact to the motor-pump casing or the motor casing immediately and/or via thermally conductive agents, such as thermally conductive pads or a thermally conductive paste.

In a further preferred embodiment of the MPU the electronic casing is arranged in the direction of the motor shaft in longitudinally extending manner and/or arranged laterally on the motor-pump casing or motor casing with reference to the motor shaft. Further, the electronic casing and/or the power board and/or the signal board extends in the direction of the motor shaft completely or substantially completely over the complete length of the motor casing and/or of the electronic casing. Thereby components of the electronic unit can be arranged on the power board and/or the signal board in a manner spatially close to components or loads within the motor-pump group, which are regulated by the electronic unit. This permits advantageously short supply lines, for example also to the pump or the pump casing. Advantageously, the pump has at least one (integrated) pressure sensor, which is electrically connected to the electronic unit and/or the signal board. Such pressure sensors are known, for example, from the document EP 3 279 476 A1, the disclosure content of which is hereby included in the disclosure content of the present description with respect to the configuration, regulation and arrangement of the pressure sensors. Correspondingly, the electronic unit and/or the signal board is set up preferably for regulating at least one pressure sensor in the pump casing of the motor-pump casing.

The invention further relates to an axle set or a motor-pump-unit axle set (MPU axle set) comprising an MPU as described above, the motor-pump group of which forms a first motor-pump group of the MPU axle set with a first hydraulic pump and a first electric motor. The MPU axle set further comprises a second motor-pump group, comprising a second hydraulic pump and a second electric motor for driving the second hydraulic pump, wherein the second motor-pump group likewise has the features and/or characteristics described above for the motor-pump group of the MPU. The electronic unit forms a common electronic unit for the independent regulation of the first and the second motor-pump group. The electronic unit comprises a power board and a signal board with the (preferred) features and/or characteristics described above, wherein the power board is preferably connected immediately to respectively the first and the second electric motor. The second motor-pump group is preferably configured to be identical or symmetrical to the first motor-pump group. Moreover, the features described for the MPU above are implemented analogously also in the MPU axle set.

In a preferred embodiment the electronic unit and/or the signal board is set up for the regulation of exactly or at least one or two external apparatuses (external with respect to the MPU axle set), in particular for the regulation of two damper adjustment valves and/or as a force modulator for two shock absorbers.

Preferably, the MPU axle set is and/or the first and the second motor-pump group and the electronic unit are arranged in a common casing or MPU axle set casing (motor-pump-unit axle set casing), which is usually a multi-part casing. This multi-part MPU axle set casing is joined exactly or at least from
a first motor-pump casing (in which the first motor-pump group is preferably received completely),
a second motor-pump casing different therefrom (in which the second motor-pump group is preferably received completely) and
an electronic casing or lid different therefrom (in which the common electronic unit is preferably received completely).

The electric lines between the electronic unit and the motor-pump groups or their electric motors preferably extend completely within the MPU axle set casing here. Further, the MPU axle set casing preferably forms a closed, sealed casing, with features and/or characteristics as described above already for the MPU casing. The common MPU axle set casing preferably comprises on its outer side, in particular on the outer side of the electronic casing, as the electric interfaces at least or exactly one bus interface (for example for a CAN bus, a CAN-FD bus or a Flexray bus) and exactly one supply voltage interface, in particular for a high voltage of, for example, 400 V or 800 V and/or for the high-voltage voltage level of a vehicle. Further, the motor-pump casings of the first and second motor-pump groups are preferably configured respectively as described above and preferably each comprise a motor casing and a pump casing.

In a preferred embodiment the MPU axle set casing and/or the electronic casing comprises, besides the bus interface and the supply-voltage interface, exactly or at least one or two further electric interfaces or exactly or at least one or two additional interfaces, for regulating the exactly or at least one or two external apparatuses, in particular one or two damper adjustment valves. Said additional interfaces form further electric casing lead-throughs, wherein on the outer side of the casing there is arranged preferably respectively one electric plug. The two or more additional interfaces are preferably mutually identical and/or configured and/or arranged to be symmetric.

In a further preferred embodiment of the MPU axle set the power board is arranged closer to the motor-pump casings and/or the motor casings than the signal board. The power board is thus located in spatial proximity of the motor-pump casings or motor casings, which contribute to heat dissipation. Further, on the power board the or all components of the power electronics are preferably arranged on the side of the power board facing towards the motor-pump group or the motor casings, which additionally promotes heat dissipation. Particularly preferably the, or all, components of the power electronics are in thermal and/or mechanical contact with the motor-pump casings or motor casings immediately and/or via thermally conductive agent, such as thermally conductive pads or a thermally conductive paste.

In a further preferred embodiment of the MPU axle set the motor shafts of the two motor-pump groups are disposed on a common axis, which preferably forms a longitudinal axis of both motor-pump casings and/or of the MPU axle set casing at the same time. Particularly preferably the pumps are arranged at respectively mutually opposing front sides of the MPU axle set and/or face away from each other. The electronic casing is preferably arranged in the direction of the common axis of the motor shafts in longitudinally extending manner and/or arranged laterally on the motor-pump casings or motor casings with reference to the common axis of the motor shafts. Further, the electronic casing and/or the power board and/or the signal board extends in the direction of the common axis of the motor shafts completely or substantially completely over the complete length of both motor casings. Components of the electronic unit on the power board and/or the signal board can thus be arranged in spatial proximity to components or loads within the motor-pump groups that are regulated by the electronic unit. This permits advantageously short supply lines. Preferably, both pumps or pump casings have respectively exactly or at least one pressure sensor (as described above) and the electronic unit and/or the signal board is preferably set up to regulate the pressure sensors.

The invention further relates to a construction kit comprising an MPU as described above or an MPU axle set as described above. The power board of the electronic unit of the MPU or the MPU axle set forms a first power board in the construction kit, said power board having a first high-voltage voltage level, i.e. being set up for a predetermined first high-voltage voltage level. Likewise, the electric motor of the or of each motor-pump group of the MPU or the MPU axle set forms respectively a first electric motor in the construction kit, said electric motor having a coil winding adapted (with respect to, for example, the coil wire diameter and/or the number of windings of the magnetic coils) to the predetermined first high-voltage voltage level.

The construction kit further comprises a second power board for the electronic unit which has a predetermined, second high-voltage voltage level different from the first one, with which the electronic unit can be operated (instead of with the first power board). The construction kit further preferably comprises also a second electric motor for the or for each motor-pump group which has a coil winding adapted to the predetermined second high-voltage voltage level, in particular has a different wire diameter and/or a different number of windings of the magnetic coils than the (respectively) first electric motor, and with which the (respective) motor-pump group can be operated (instead of with the first electric motor).

The construction kit according to the invention thus creates an MPU or an MPU axle set that can be adapted easily to different high-voltage voltage levels, in particular by exchanging the power board only and, optionally, by exchanging the electric motors and/or motor-pump groups.

In a preferred embodiment of the construction kit the first and the second power board have an identical circuit-board layout. The first and the second power board differ from each other, for example, only with respect to the respective equipment, for example with the (power) electronic components. The first power board preferably has a voltage level of 400 V and the second power board has a voltage level of 800 V.

The chassis system according to the invention or a chassis axle for a vehicle according to the invention comprises exactly or at least a first and second hydraulically actively controllable shock absorber with respectively two damper or pressure chambers, for example separated by a movable damper piston, which are preferably allocated to or arranged on one common chassis axle, as well as at least a first and a second MPU as described above or at least one MPU axle set as described above, wherein the motor-pump group of the first MPU or the first motor-pump group of the MPU axle set hydraulically interconnects the pressure chambers of the first shock absorber and the motor-pump group of the second MPU or the second motor-pump group of the MPU axle set hydraulically interconnects the pressure chambers of the second shock absorber. Thereby, for example a “soft” or “hard” damping can be set, by the respective motor-pump group damping or throttling, for example, pressure surges from the pressure chambers to a greater or lesser degree. In this case, the respective motor-pump group is thus driven hydraulically, so that the electric motors of the motor-pump groups can be operated as electric motor generators and thus electric energy can be recuperated (recuperation). Further, also the zero position or rest position of the shock absorbers can be set actively or in targeted manner and can also be changed (constantly) during the driving operation (active chassis). It is understood that the chassis system can have one or several further axles preferably configured likewise.

Preferably, the hydraulically actively controllable shock absorbers of the chassis axle or of the chassis system further have electrically regulatable damper adjustment valves which are regulated by the motor-pump units or the MPU axle set. A shock absorber has exactly or at least one damper adjustment valve, which (additionally or in parallel to the hydraulic pump of the respective motor-pump group) hydraulically connects the two pressure chambers of the shock absorber and therein acts as an (electrically) adjustable throttle. The damper adjustment valve forms an external apparatus here as described above. The electronic unit and/or the signal board of the motor-pump units and/or of the MPU axle set is/are preferably configured respectively as a force modulator for the respectively connected shock absorber(s). As the force modulator the electronic unit of the MPU or of the MPU axle set combines the hydraulic regulation of the shock absorber via the pump of the respective motor-pump group and the electric regulation of the damper adjustment valve. It is thus set up to modulate the interaction of the pump or motor-pump group and the damper adjustment valve for the regulated shock absorber. A chassis control device, which forms a superordinate control device for the electronic unit(s) of the MPU or MPU axle set, thus merely has to specify a damper force desired for a shock absorber. A force modulator in the form of a dedicated, interposed control device can be omitted. Correspondingly, in the chassis system the MPU is set up to be regulated directly and immediately by a (superordinate) chassis control device (via the bus interface) and, in particular, to receive and/or to process the damper force for the shock absorber as the only target value.

### BRIEF DESCRIPTION OF THE DRAWINGS

The invention will hereinafter be described by way of example with reference to the attached drawings. The drawings are merely schematic representations and the invention is not limited to the specific represented embodiment examples.

FIG. 1 shows a perspective exploded view of an MPU,

FIG. 2 shows a perspective exploded view of an MPU axle set,

FIG. 3 shows a perspective view of a power board and a signal board, and

FIG. 4 shows a schematic view of an axle of a chassis system with an MPU axle set.

### DETAILED DESCRIPTION

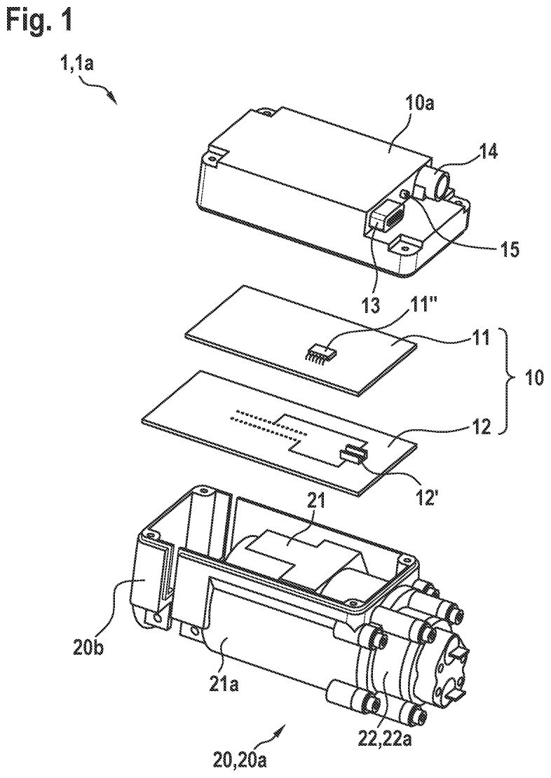

FIG. 1 represents a perspective exploded view of a motor-pump unit 1 with a common motor-pump unit casing 1a. The motor-pump unit casing 1a in the represented embodiment example consists of an electronic casing 10a, which accommodates the electronic unit 10, a motor-pump casing 20a, which accommodates the motor-pump group 20, and a casing lid 20b. The motor-pump casing 20a consists of a motor casing 21a, which accommodates the electric motor 21, and a multi-part pump casing 22a, in the embodiment example, which accommodates the pump 22. The electric motor 21 and the pump 22 are fixedly connected via a not represented rotatable motor shaft.

The electronic unit 10 comprises two circuit boards, a signal board 11 and a power board 12, which are laid out for different voltage levels. The electronic casing 10a comprises a bus interface 13, a supply-voltage interface 14 and an additional interface 15. The bus interface 13 serves for communication with a superordinate chassis control device 16, while the supply voltage of the high-voltage voltage level of the electronic unit 10 or of the power board 11 is fed via the supply-voltage interface 14. The additional interface 15 is provided for the regulation or operation of an external apparatus, in particular of a damper adjustment valve 54′ of a shock absorber 54.

In the electronic unit 10 the two circuit boards 11, 12 are arranged parallel to each other or above each other and mutually spaced apart, wherein the power board 12 is arranged on the side of the electronic unit 10 facing towards the electric motor 21 and is in contact with the motor casing 21a via not represented thermally conductive agents. In the embodiment example the power board is arranged laterally on the motor casing 21a and substantially extends over the complete motor casing 21a, which permits short paths between the power board 12 and all components to be regulated (magnetic coil, pressure sensors, etc.). The signal board 11 also extends substantially over the complete motor casing 21a in the represented embodiment example.

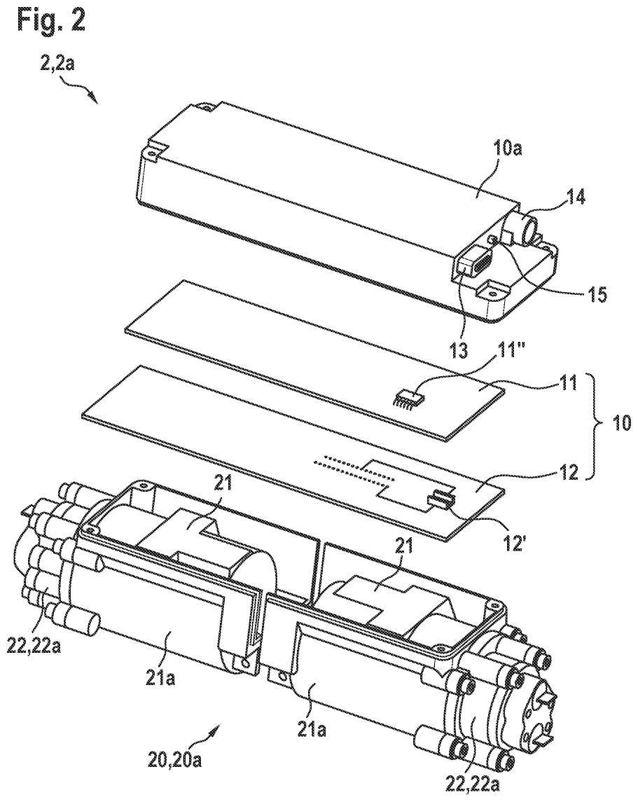

FIG. 2 represents a perspective exploded view of a motor-pump-unit axle set 2 in an MPU axle set casing 2a. Said axle set comprises two motor-pump groups 20 with corresponding motor-pump casings 20a. The electronic unit 10 here forms a common electronic unit for both motor-pump groups 20 and extends substantially completely over both motor-pump casings 20a or their motor casings 21a. Likewise, the power board 11 is in contact with the two motor casings 21a via thermally conductive agents, which are again not represented.

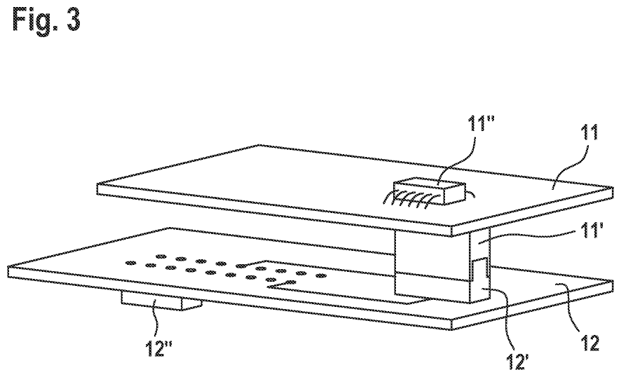

FIG. 3 represents a perspective view of the two circuit boards (signal board 11, power board 12) of the electronic unit 10. These are interconnected mechanically and electrically via a plug-in system 11′, 12′. The plug-in system comprises two corresponding circuit board plugs, a signal circuit board plug 11′ and a power circuit board plug 12′, each of which are fixedly soldered to the circuit board. On the signal board 11 a CPU 11″ is arranged, and the power switching transistors 12″ of a B6 bridge circuit are arranged on the side of the power board 12 facing towards the motor casing 21a and away from the signal board 11.

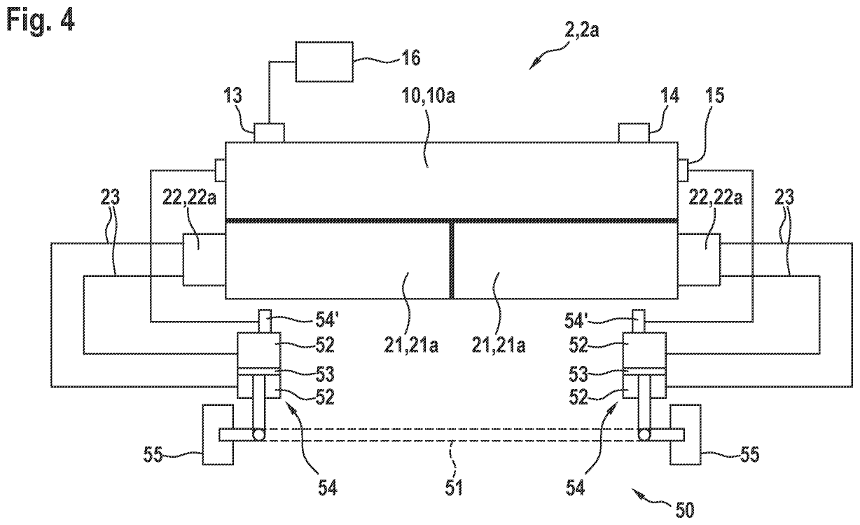

FIG. 4 schematically represents a chassis axle 51 of a chassis system 50 with a motor-pump-unit axle set 2. Hydraulic lines 23 lead respectively from the pumps 22 or the pump casings 22a to the pressure chambers 52 of a shock absorber 54. The two pressure chambers 52 of a shock absorber 54 are separated by a piston 53 that is axially movable in a damper cylinder. In the represented embodiment example the cylinders of the shock absorbers are connected respectively with the suspended mass of the vehicle or the chassis, while the pistons 53 are connected or coupled with the unsuspended mass of the vehicle or a wheel 55 and/or a chassis axle 51. However, this can also be configured the other way around. Further, in the schematic representation the spring elements usually further provided, for example a pneumatic spring and/or a steel spring, have been omitted.

Electric lines extend via the additional interface 15 to damper adjustment valves 54′ of the shock absorbers 54, which form adjustable throttle elements for the hydraulic fluid flow between the two pressure chambers 52. These damper adjustment valves can be arranged in the manner known per se, for example at or on the piston 53 or between the damper chambers 52 in additional fluid channels extending laterally at the damper cylinder. Correspondingly, the electronic unit 10 or the signal board 11 of the MPU axle set 2 is set up as a force modulator for the two shock absorbers 54.

### LIST OF REFERENCE NUMERALS

1 MPU
1a MPU casing
2 MPU axle set
2a MPU axle set casing
10 electronic unit
10a electronic casing
11 signal board
11′ signal-board plug
11″ CPU, microprocessor
12 power board
12′ power-board plug
12″ power switching transistor, B6 bridge, power electronics
13 bus interface
14 supply voltage interface
15 additional interface
16 chassis control device, superordinate control device
20 motor-pump group
20a motor-pump casing
20b casing lid
21 electric motor, electric motor generator
21a motor casing
22 pump
22a pump casing
23 hydraulic line
50 chassis system
51 chassis axle
52 pressure chamber
53 piston
54 shock absorber
54′ damper adjustment valve, external apparatus
55 wheel

1. A motor-pump unit for making available hydraulic energy, in particular in a chassis system of a vehicle, comprising
a motor-pump group, comprising a hydraulic pump and an electric motor for driving the hydraulic pump, and
an electronic unit for regulating the motor-pump group,
wherein the electronic unit has a power board with power electronics and a signal board that is preferably constructively separate.

2. The motor-pump unit according to claim 1, wherein the power board has a high-voltage voltage level and the signal board has a low-voltage voltage level, which is smaller than the high-voltage voltage level, wherein preferably the high-voltage voltage level amounts to 12 V, 24 V, 48 V, 400 V or 800 V and/or the low-voltage voltage level amounts to 5 V, 12 V, 24 V or 48 V.

3. The motor-pump unit according to claim 1, wherein
the power electronics comprises power switching transistors, in particular a B6 bridge and/or a voltage converter from the high-voltage to the low-voltage voltage level, and/or a supply voltage interface for the voltage supply of the signal board and/or a (high-voltage) supply voltage interface, and/or
the signal board comprises a CPU, a microprocessor and/or an FPGA and/or a bus interface and/or a supply voltage interface for the voltage supply of the signal board and/or a galvanic separation or galvanic separating elements between the supply voltage interface on the one hand and the bus interface on the other hand.

4. The motor-pump unit according to claim 1,
wherein the power board and the signal board are interconnected via a plug-in system, and/or
wherein the power board and the signal board are arranged parallel to each other and/or components of the power electronics are arranged on a side of the power board facing away from the signal board, and/or
wherein the electronic unit and/or the signal board is/are set up for regulating exactly or at least one external apparatus, in particular for regulating one or several damper adjustment valves, and/or
wherein the electronic unit and/or the signal board is set up as a force modulator for one or several shock absorbers, and/or
wherein the power board is set up to generate a supply voltage of the signal board.

5. The motor-pump unit according to claim 1,
wherein the motor-pump unit comprises a motor-pump unit casing, which preferably comprises a motor-pump casing and an electronic casing, wherein the motor-pump unit casing and/or the electronic casing comprises a bus interface and a supply voltage interface and preferably an electric additional interface for regulating the exactly or at least one external apparatus, and/or
wherein the power board is arranged closer to the motor-pump casing and/or a motor casing of the motor-pump casing than the signal board and/or
wherein the components of the power electronics
are arranged on a side of the power board facing towards the motor casing and/or
are in thermal and/or mechanical contact with the motor casing immediately and/or
via thermally conductive agents, and/or
wherein the electronic casing and/or the power board and/or the signal board extends completely or substantially completely over the motor casing and/or is arranged laterally on the motor-pump casing and/or motor casing, and/or
wherein the electronic unit and/or the signal board is/are set up for regulating at least one pressure sensor in a pump casing of the motor-pump casing and/or is/are connected to the pressure sensor.

6. A motor-pump-unit axle set comprising a motor-pump unit according to claim 1, the motor-pump group of which firms a first motor-pump group with a first hydraulic pump and a first electric motor,
wherein the motor-pump-unit axle set comprises a second motor-pump group, comprising a second hydraulic pump and a second electric motor for driving the second hydraulic pump, and
wherein the electronic unit forms a common electronic unit for regulating the first and second motor-pump groups.

7. The motor-pump-unit axle set according to claim 6,
wherein the electronic unit and/or the signal board is/are set up for regulating at least or exactly one or two external apparatuses, in particular for regulating two or several damper adjustment valves, and/or
wherein the electronic unit and/or the signal board is set up as a force modulator for two or more shock absorbers.

8. The motor-pump-unit axle set according to claim 6,
wherein the motor-pump-unit axle set comprises a motor-pump-unit axle set casing, which preferably comprises two motor-pump casings and an electronic casing, and/or
wherein the motor-pump-unit axle set casing and/or the electronic casing comprises a bus interface and a supply voltage interface and preferably one or two electric additional interfaces for regulating the exactly or at least one or two external apparatuses, and/or
wherein the power board is arranged closer to the motor-pump casings and/or motor casings of the motor-pump casings than the signal board, and/or
wherein the components of the power electronics
are arranged on a side of the power board facing towards the motor casings and/or
are in thermal and/or mechanical contact with the motor casings immediately
and/or via thermally conductive agents, and/or
wherein the motor-pump casings and/or their motor casings are arranged on a common axis, and/or
wherein the electronic casing and/or the power board and/or the signal board extends completely or substantially completely over both motor casings and/or is arranged laterally on the motor-pump casings and/or motor casings, and/or
wherein the electronic unit and/or the signal board is/are set up for regulating at least one pressure sensor in pump casings of the two motor-pump casings and/or is/are connected to the pressure sensors.

9. A construction kit comprising a motor-pump unit according to claim 1, wherein the power board forms a first power board which has a predetermined first high-voltage voltage level,
and the electric motor(s) form first electric motors, with a coil winding adapted to the first high-voltage voltage level, further comprising
a second power board which has a predetermined second high-voltage voltage level different from the first one, and preferably
a second electric motor for the or for each motor-pump group, which has a coil winding adapted to the predetermined second high-voltage voltage level, in particular with a coil winding that is different from the first electric motor.

10. The construction kit according to claim 9, wherein the first and second power boards have an identical circuit board layout and preferably have voltage levels of 400 V and 800 V.

11. A chassis axle comprising a motor-pump-unit axle set according to claim 6,
wherein the chassis axle is preferably pre-assembled and/or has two hydraulically regulatable shock absorbers, which are particularly preferably hydraulically connected respectively to the pumps of the first and the second motor-pump group of the motor-pump-unit axle set, and/or
wherein the shock absorbers have respectively exactly or at least one electrically regulatable damper adjustment valve, which are regulated respectively by the motor-pump-unit axle set or the electronic unit thereof, and/or
wherein the electronic unit and/or the signal board is/are set up as a force modulator for the shock absorbers.

12. A chassis axle comprising two motor-pump units according to claim 1,
wherein the chassis axle is preferably pre-assembled and/or has two hydraulically regulatable shock absorbers, which are particularly preferably hydraulically connected respectively to the pumps of the two motor-pump units, and/or
wherein the shock absorbers have respectively exactly or at least one electrically regulatable damper adjustment valve, which are respectively regulated by one of the two motor-pump units or the electronic units thereof, and/or
wherein the electronic unit and/or the signal board of the motor-pump units are respectively set up as a force modulator for the respective shock absorber.

13. A chassis system for a vehicle, comprising
a first chassis axle and second chassis axle according to claim 11,
a chassis control device which is connected to the electronic units of the motor-pump units and/or the motor-pump-unit axle sets via the bus interface.
